(19) United States
(12) Patent Application Publication
(10) Pub. No.: US 2007/0173630 A1
(43) Pub. Date: Jul. 26, 2007

(54) Macrocyclic polyester oligomers as flow modifier additives for thermoplastics

(75) Inventors: Steven R. Bahr, Schenectady, NY (US); Nathan Doyle, Troy, NY (US); Jing Wang, Clifton Park, NY (US); Steven J. Winckler, Troy, NY (US); Tohru Takekoshi, Scotia, NY (US)

Correspondence Address: GOODWIN PROCTER LLP;PATENT ADMINISTRATOR, EXCHANGE PLACE, BOSTON, MA, 02109-2881, US

(73) Assignee: Cyclics Corporation, Schenectady, NY (US)

(21) Appl. No.: 11/607,465

(22) Filed: Dec. 1, 2006

Related U.S. Application Data
(60) Provisional application No. 60/742,110, filed on Dec. 2, 2005.

(51) Int. Cl. C08G 63/02

(52) U.S. Cl. 528/272

(57) ABSTRACT

This invention relates generally to the use of macrocyclic polyester oligomers, and certain other cyclic oligomers, as additives in linear thermoplastics for improved flow and/or processibility. More particularly, in certain embodiments, the invention relates to compositions containing up to about 10 wt. % cyclic oligomer, and their use in manufacturing processes, such as injection molding operations.

### PRIORITY APPLICATION

This application claims the benefit of U.S. Provisional Patent Application No. 60/742,110, filed on Dec. 2, 2005, which is hereby incorporated by reference in its entirety.

### FIELD OF THE INVENTION

This invention relates generally to the use of macrocyclic polyester oligomers, and certain other cyclic oligomers, as additives in compositions of linear thermoplastics for improved flow and/or processibility. More particularly, in certain embodiments, the invention relates to compositions containing up to about 10 wt. % cyclic oligomer, and their use in manufacturing processes, such as injection molding operations.

### BACKGROUND OF THE INVENTION

The flow properties of linear thermoplastics are important in certain manufacturing processes, such as injection molding. The adjustment of the melt flow properties of linear thermoplastics is typically handled by adjusting the molecular weight of the polymer. For example, two or more grades of polymer, each having a different average molecular weight, may be mixed to provide a polymer composition with adequate melt flow rate in an injection molding process.

### SUMMARY OF THE INVENTION

Macrocyclic polyester oligomers, as well as certain other cyclic oligomers, can be used as additives in compositions of linear thermoplastics for improved flow and/or processibility. In this way, for example, it is possible for resin manufacturers, compounders, and injection molders to vary the melt flow of a polymer having a particular molecular weight (or molecular weight range) by adding a small amount of cyclic oligomer, rather than by mixing several base grades having different molecular weights.

Improved melt flow rate is demonstrated herein using macrocyclic polyester oligomers (MPOs) as additives for thermoplastics, in amounts less than 5 wt. %, without significant effects on the other properties of the resulting compositions, such as toughness, strength, and impact resistance. In certain embodiments, the amount of MPO used as flow modifier additive is less than about 10 wt. %, less than about 7 wt. %, less than about 3 wt. %, less than about 2 wt. %, less than about 1 wt. %, or less than about 0.5 wt. %.

It is also demonstrated herein that macrocyclic polyester oligomers may be used as additives in linear polymers in an injection molding process for producing bottle preforms. The use of the cyclic oligomers provides improved flow, reduced molding pressure, and reduced energy consumption, with negligible effect on properties of the bottle preforms or the bottles themselves. The optical properties and acetaldehyde content of bottles blown from these preforms are substantially unaffected by the use of the macrocyclic polyester oligomers.

In certain embodiments, a pressure reduction can be achieved in an injection molding process. A pressure reduction of about 20% was demonstrated with a thermoplastic composition containing about 2 wt. % macrocyclic poly(butylene terephthalate) oligomer as flow modifier. The improved flow of compositions in the injection molding of thermoplastics provides, for example, lower molding pressures and lower part stress. This results in a reduced energy requirement, improved throughput, and increased productivity, and the ability, for example, to injection mold larger parts and/or parts with thinner wall sections. The benefits of lower molded part stress may be observed, for example, in reduced warpage, improved dimensional stability, and lower birefringence of the molded product.

The need to mix multiple grades of linear polymers in the manufacturing of thermoplastic parts may be eliminated or reduced, since embodiments of the invention allow more versatile use of linear polymer of a given grade. This may lead, for example, to an improvement in overall compounding throughput, and may allow increased usage of recycled and/or other commercial grades of thermoplastics.

In one aspect, the invention relates to a linear polymer composition containing up to about 10 wt. % cyclic oligomer as flow modifier. The cyclic oligomer is preferably a macrocyclic oligomer. In certain embodiments, the amount of cyclic oligomer is less than about 7 wt. %, less than about 5 wt. %, less than about 3 wt. %, less than about 2 wt. %, less than about 1 wt. %, or less than about 0.5 wt. %. In certain embodiments, the amount of cyclic oligomer used in between about 0.5 wt. % and about 3 wt. %.

In certain embodiments, the cyclic oligomer used as flow modifier includes a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and/or co-oligomers thereof. In some embodiments, the cyclic oligomer contains or is a macrocyclic polyester oligomer, for example, a macrocyclic poly(butylene terephthalate) oligomer, a macrocyclic poly(ethylene terephthalate) oligomer, and/or co-oligomers thereof. The macrocyclic polyester oligomer may be aliphatic or aromatic, for example.

In one embodiment, the cyclic oligomer includes a lactone, a caprolactone (i.e. cyclic poly(caprolactone) oligomer), and/or a lactic acid dimer.

The linear polymer composition may have as its linear polymer one or more polyesters, polyolefins, polyformals, polyphenylene oxides, polyphenylene sulfides, polyphenylsulfones, polyetherimides, and/or co-polymers thereof. In some embodiments, the linear polymer is a polyester. In certain embodiments, the linear polymer includes polybutylene terephthalate (PBT), polyethylene terephthalate (PET), and/or copolyesters thereof.

The cyclic oligomer(s) and the linear polymer may have monomeric units that are the same as each other, or are different. For example, cyclic poly(butylene terephthalate) oligomer may be used as a flow modifier for PBT (where the monomeric units of the cyclic oligomer and the linear polymer are the same), while cyclic poly(butylene terephthalate) oligomer may also be used as a flow modifier for PET (where the monomeric units of the cyclic oligomer and the linear polyer are different).

In certain embodiments, the invention relates to a manufacturing process (for example, a molding process, or more particularly, an injection molding process) involving one or more of the compositions above. In certain embodiments, use of the composition allows reduced energy consumption of the manufacturing process.

In another aspect, the invention relates to a method for preparing bottle preforms, the method including the steps of preparing one or more of the above-described compositions, and injection molding the composition(s) to form a bottle preform. In certain embodiments, the method further includes the step of blow molding a bottle from the bottle preform, where the optical properties of the bottle are substantially unaffected by the use of the cyclic oligomer as flow modifier. In some embodiments, the presence of the cyclic oligomer in the composition allows for a reduction of at least about 5%, 10%, 15%, 18%, or 20% in switch over pressure.

### BRIEF DESCRIPTION OF FIGURES

FIG. 1 is a schematic flow diagram of a method for preparing bottle preforms, according to an illustrative embodiment of the invention.

### DETAILED DESCRIPTION

As used herein, “macrocyclic” is understood to mean a cyclic molecule having at least one ring within its molecular structure that contains 5 or more atoms covalently connected to form the ring.

As used herein, an “oligomer” is understood to mean a molecule that contains one or more identifiable structural repeat units of the same or different formula.

As used herein, a “macrocyclic polyester oligomer” is understood to mean a macrocyclic oligomer containing structural repeat units having an ester functionality. A macrocyclic polyester oligomer typically refers to multiple molecules of one specific repeat unit formula. However, a macrocyclic polyester oligomer also may include multiple molecules of different or mixed formulae having varying numbers of the same or different structural repeat units. In addition, a macrocyclic polyester oligomer may be a co-polyester or multi-component polyester oligomer, i.e., an oligomer having two or more different structural repeat units having ester functionality within one cyclic molecule.

Throughout the description, where compositions, mixtures, blends, and composites are described as having, including, or comprising specific components, or where processes and methods are described as having, including, or comprising specific steps, it is contemplated that, additionally, there are compositions, mixtures, blends, and composites of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

Scale-up of systems from laboratory to plant scale may be performed by those of ordinary skill in the field of polymer manufacturing and processing.

It is contemplated that information from the following documents can be used in the practice of and/or adaptation of the embodiments of the invention: U.S. patent application No. 10/860,431, published as U.S. Patent Application Publication No. US2004/0220334 A1, titled, “Blends Containing Macrocyclic Polyester Oligomer and High Molecular Weight Polymer,” by Wang et al.; U.S. Pat. No. 6,420,047, titled, “Macrocyclic Polyester Oligomers and Processes for Polymerizing the Same,” by Winckler et al.; U.S. Pat. No. 6,369,157, titled, “Blend Material Including Macrocyclic Polyester Oligomers and Processes for Polymerizing the Same,” by Winckler et al.; and U.S. Pat. No. 6,960,626, titled, “Intimate Physical Mixtures Containing Macrocyclic Polyester Oligomer and Filler,” by Takekoshi et al.; each of which is hereby incorporated herein by reference in its entirety. For example, it is contemplated that the cyclic oligomers, linear polymers, and/or processes described in the aforementioned documents can be used in various embodiments of the invention.

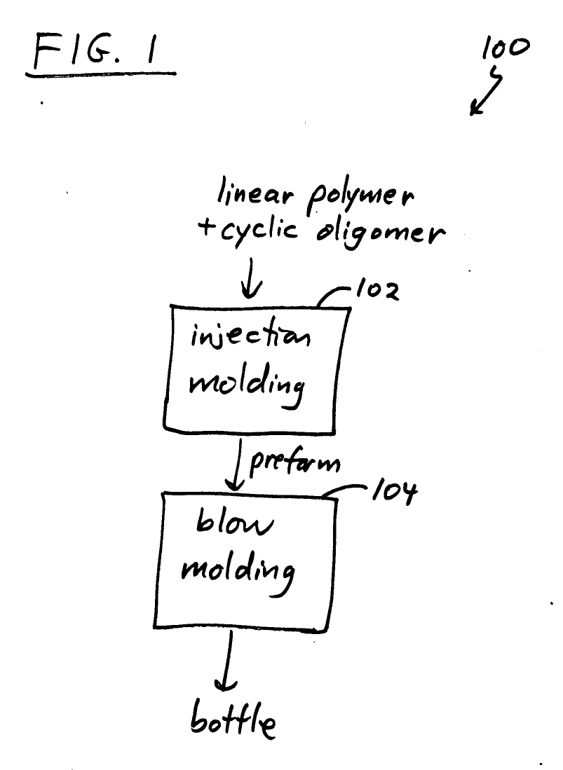

FIG. 1 is a schematic flow diagram 100 of a method for preparing bottle preforms. Linear polymer, with cyclic oligomer added as flow modifier, is introduced into the injection mold 102 to prepare a preform. The preform is then blow molded 104 to form a bottle. The optical properties are substantially unaffected by the use of the cyclic oligomer as flow modifier.

### EXPERIMENTAL EXAMPLES

Experiments were conducted to demonstrate various embodiments of the invention. The experiments involved the use of the linear thermoplastic polyester, polyethylene terephthalate (PET), Eastman Voridian CB 12, provided by Eastman Chemical Company of Kingsport, Tenn. The cyclic oligomer used in the experiments is cyclic poly(butylene terephthalate), CBT®100, which is a macrocyclic polyester oligomer, provided by Cyclics®° Corporation of Schenectady, N.Y. This material is referred to herein as cPBT.

### Examples 1a-d

### Demonstration of Improved Melt Flow Rate of PET Compositions with cPBT as Additive with Negligible Change in Mechanical Properties

Blends of the above-identified linear thermoplastic PET and cyclic oligomer cPBT were created using a Leistritz LSM 34 mm counter-rotating twin screw extruder, with barrel temperature from about 250° C. to about 280° C., operating at about 150 rpm. Table 1 shows the intrinsic viscosity, melt flow rate, yield strength, Young's modulus, elongation, and “Dart” impact strength of compositions 1a to 1d. Specimens were made and conditioned according to ASTM standard method D5229, and tensile tests were performed at 50 mm/min according to ASTM D638 standard method. High speed puncture tests were performed at 3.3 m/s according to ASTM D3763 standard method. Melt flow index was measured according to ASTM D1238 standard method, and intrinsic viscosity was measured according to ASTM D2857 standard method.

Sample 1a is a control sample of PET that has not been extruded. Sample 1b is a control sample of PET that has been extruded using the twin screw extruder as described above. The properties of sample 1b indicate some change in viscosity and melt flow rate due to the extrusion.

Compositions 1c and 1d were prepared by blending cPBT and PET via twin-screw extrusion as described above. Composition 1c contains about 0.5 wt. % cPBT, with the remainder PET, while composition 1d contains about 3 wt. % cPBT, with the remainder PET.

There is significant increase in melt flow rate (MFR) with the addition of cPBT in compositions 1c and 1d, as shown in Table 1, even with negligible change in the intrinsic viscosity. There is negligible degradation of tensile properties due to the presence of cPBT, as seen in Table 1.

### Example 2

### Injection Molding of Bottle Preforms Made of PET with cPBT as Additive, Demonstrating Reduced Pressure and Reduced Energy Requirement

Injection molding of bottle preforms was performed using PET and using PET with cPBT additive in order to demonstrate the improvement afforded by the use of the additive. In the experiment using only PET, the PET pellets were powdered in a laboratory grinder into a −30 mesh powder using a Waring lab blender. This material was then placed in a hopper for feeding into the injection molding machine. For the experiment using PET with cPBT as additive, PET pellets and cPBT pellets were powdered in a laboratory grinder into a −30 mesh powder using a Waring lab blender to form a composition of 98 wt. % PET and 2 wt. % cPBT. This material was then placed into a hopper for feeding into the injection molding machine.

Resin samples were injection molded on an Arburg 320M reciprocating screw molding machine using a 24.5 +/−0.5 g, 20 oz. carbonated soft drink style tool. Process parameters were optimized to achieve a clear part at the lowest possible injection molding temperatures (barrel temperatures=268° C.; mold temperature=58° F.; injection pressure 700 bar; injection speed 3.5 sec). The switch over pressure and cycle times are indicated in Table 2, and the hydraulic energy, thermal energy, and total energy consumption of the injection molding process are shown in Table 3.

A significant reduction in switch over pressure—about a 20 % reduction—was observed with the composition of 98 wt. % PET and 2 wt. % cPBT. An overall reduction in total energy consumption was observed, as shown in Table 3.

Acetaldehyde forms when PET degrades, and can alter the taste and smell of the contents of the container. It is preferable that the level of acetaldehyde in the bottle material be low. The acetaldehyde content of the bottle preforms were measured. Three preforms of each type were ground to a small particle size and placed in sealed glass vials, which were placed in a heated block at 150° C. for 30 minutes. A sample of the headspace of each vial was injected into a gas chromatograph and the acetaldehyde content was measured using reference calibration standards. Table 4 shows that the average acetaldehyde content of the bottle preforms made from PET with cPBT additive is no more than that of the bottle preforms made from PET, and in fact, is less.

### Example 3

### Blow Molding of Bottle Preforms of Example 2 Demonstrating Negligible Degradation of Bottle Properties

The bottle preforms made in Example 2 were heated to 100° C. and placed onto a mandrel on a free blow molding device. The preforms were then subjected to axial extension of approximately 0.25″ and then pressurized with air to allow the preform to fully orient.

Optical measurements were performed on a ColorQuest II calorimeter, and are shown Table 5. Optical measurements were performed on both the preforms and the blow molded bottles. The results indicate very small differences or negligible differences in optical properties of the blow-molded bottles made using cPBT additive, versus bottles without the cPBT additive.

TABLE 1
Average Values of Selected Properties for PET Blends.

| | | | | Yield | Young's | | Impact |
|---|---|---|---|---|---|---|---|
| Sample | % CBT | IV | MFR | Strength | Modulus | Elongation | Strength |
| # | 100 ® | dl/gm | g/10 min | MPa | GPa | % | J |
| 1a | 0 (Not extruded) | 0.85 | 57 | 52.9 | 2.3 | 241 | 49.6 |
| 1b | 0 (Extruded) | 0.72 | 93 | N/A | N/A | N/A | N/A |
| 1c | 0.5 | 0.72 | 140 | 53.7 | 2.3 | 259 | 51.5 |
| 1d | 3 | 0.7 | 250 | 56.5 | 2.4 | 235 | 50.6 |

TABLE 2
Preform Injection Molding Parameters

| | | | | | | Switch | |
|---|---|---|---|---|---|---|---|
| | Actual Temperatures C. | | | | | Over | Cycle |
| | | Zone | Zone | Zone | Zone | pressure | Time |
| Material | Feed | 1 | 2 | 3 | 4 | (Bar) | (sec) |
| PET (As | 268 | 268 | 268 | 268 | 268 | 397.4 | 27.63 |
| Received) | | | | | | | |
| PET/CBT | 268 | 268 | 268 | 268 | 268 | 319.6 | 27.61 |
| 100 2 wt % | | | | | | | |

TABLE 3
Energy Consumption of Injection Molder

| | PET/CBT | PET | % |
|---|---|---|---|
| Parameter | Blend | Control | Difference |
| Hydraulic Energy (KWH/min) | 0.988 | 1.036 | 4.6 |
| Thermal Energy (KWH/min | 0.305 | 0.296 | −3.0 |
| Total Energy Consumption | 1.293 | 1.332 | 2.9 |
| (KWH/min) | | | |

TABLE 4
Acetaldehyde Content of Bottles

| | Acetaldehyde Content |
|---|---|
| Sample | (micrograms/g) |
| PET/CBT Blend | 7.08 ± 0.25 |
| PET Control | 7.44 ± 0.14 |

TABLE 5
Optical Properties of Blended Preforms and Bottles

| Sample | L* | a* | b* | Haze | ΔE |
|---|---|---|---|---|---|
| Bottle | | | | | |
| PET/CBT Blend | 93.86 ± 0.02 | −0.18 ± 0.01 | 0.84 ± 0.03 | 1.77 ± 0.03 | 5.17 ± 0.02 |
| PET Control | 93.83 ± 0.04 | −0.17 ± 0.01 | 0.83 ± 0.01 | 1.83 ± 0.04 | 5.19 ± 0.04 |
| Preform | | | | | |
| PET/CBT Blend | 81.56 ± 0.22 | −0.45 ± 0.17 | 1.84 ± 0.04 | 9.92 ± 0.15 | 18.46 ± 0.23 |
| PET Control | 81.56 ± 0.24 | −0.37 ± 0.03 | 1.60 ± 0.05 | 9.84 ± 0.35 | 18.44 ± 0.25 |

TABLE 6
Test Standards used

| Test | Standard Used |
|---|---|
| Tensile Test (50 mm/min) | ASTM D638 |
| High Speed Puncture (“Dart”) 3.3 m/s | ASTM D3763 |
| Sample Conditioning | ASTM D5229 |
| Melt Flow Index | ASTM D1238 |
| Intrinsic Viscosity | ASTM D2857 |

### Equivalents

While the invention has been particularly shown and described with reference to specific preferred embodiments, it should be understood by those skilled in the art that various changes in form and detail may be made therein without departing from the spirit and scope of the invention as defined by the appended claims. Furthermore, what is considered applicants' invention is not necessarily limited to embodiments that fall within the claims below.

What is claimed is:

1. A composition comprising:
(a) linear polymer; and
(b) cyclic oligomer as flow modifier, wherein the composition comprises up to about 10 wt. % cyclic oligomer.

2. The composition of claim 1, wherein the composition comprises up to about 7 wt. % cyclic oligomer.

3. The composition of claim 1, wherein the composition comprises up to about 5 wt. % cyclic oligomer.

4. The composition of claim 1, wherein the composition comprises up to about 3 wt. % cyclic oligomer.

5. The composition of claim 1, wherein the composition comprises up to about 2 wt. % cyclic oligomer.

6. The composition of claim 1, wherein the composition comprises up to about 1 wt. % cyclic oligomer.

7. The composition of claim 1, wherein the cyclic oligomer comprises at least one member selected from the group consisting of a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and co-oligomers thereof.

8. The composition of claim 1, wherein the cyclic oligomer comprises a macrocyclic polyester oligomer.

9. The composition of claim 8, wherein the macrocyclic polyester oligomer comprises at least one member selected from the group consisting of macrocyclic poly(butylene terephthalate) oligomer, macrocyclic poly(ethylene terephthalate) oligomer, and co-oligomers thereof.

10. The composition of claim 8, wherein the macrocyclic polyester oligomer is aliphatic.

11. The composition of claim 8, wherein the macrocyclic polyester oligomer is aromatic.

12. The composition of claim 1, wherein the cyclic oligomer comprises a lactone.

13. The composition of claim 1, wherein the cyclic oligomer comprises a caprolactone.

14. The composition of claim 1, wherein the cyclic oligomer comprises a lactic acid dimer.

15. The composition of claim 1, wherein the linear polymer comprises at least one member selected from the group consisting of a polyester, a polyolefin, a polyformal, a polyphenylene oxide, a polyphenylene sulfide, a polyphenylsulfone, a polyetherimide, and co-polymers thereof.

16. The composition of claim 1, wherein the linear polymer comprises a polyester.

17. The composition of claim 16, wherein the polyester comprises at least one member selected from the group consisting of a polybutylene terephthalate, a polyethylene terephthalate, and co-polyesters thereof.

18. The composition of claim 1, wherein the cyclic oligomer comprises a species having a monomeric unit in common with a monomeric unit of at least one species of the linear polymer.

19. The composition of claim 1, wherein the cyclic oligomer comprises a species having a monomeric unit different from the monomeric units that make up the linear polymer.

20. A process, comprising the step of:
injection molding a composition; the composition comprising:
(a) linear polymer; and
(b) cyclic oligomer, wherein the composition comprises up to about 10 wt. % cyclic oligomer, and the cyclic oligomer allows reduced energy consumption during the injection molding.

21. The process of claim 20, wherein the cyclic oligomer comprises at least one member selected from the group consisting of a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and co-oligomers thereof.

22. The process of claim 20, wherein the cyclic oligomer comprises a macrocyclic polyester oligomer.

23. The process of claim 20, wherein the linear polymer comprises at least one member selected from the group consisting of a polyester, a polyolefin, a polyformal, a polyphenylene oxide, a polyphenylene sulfide, a polyphenylsulfone, a polyetherimide, and co-polymers thereof.

24. A method for preparing bottle preforms, wherein the method comprises the steps of:
(a) preparing a composition comprising:
(i) linear polymer; and
(ii) cyclic oligomer as flow modifier, wherein the composition comprises up to about 10 wt. % cyclic oligomer; and
(b) injection molding the composition to form a bottle preform.

25. The method of claim 24, further comprising the step of:
(c) blow molding a bottle from the bottle preform, wherein the optical properties of the bottle are substantially unaffected by the use of the cyclic oligomer as flow modifier.

26. The method of claim 24, wherein the presence of the cyclic oligomer in the composition allows a reduction of at least about 10% in switch over pressure.

27. The method of claim 24, wherein the presence of the cyclic oligomer in the composition allows a reduction of at least about 15% in switch over pressure.

28. A method of preparing a blend, comprising the step of:
contacting a linear polymer with a cyclic oligomer to form a blend,
wherein the blend comprises up to about 10 wt. % cyclic oligomer.

29. The method of claim 28, wherein the blend comprises up to about 5 wt. % cyclic oligomer.

30. The method of claim 28, wherein the blend comprises up to about 1 wt. % cyclic oligomer.

31. The method of claim 28, wherein the cyclic oligomer comprises at least one member selected from the group consisting of a cyclic polyester oligomer, a cyclic polyolefin oligomer, a cyclic polyformal oligomer, a cyclic poly(phenylene oxide) oligomer, a cyclic poly(phenylene sulfide) oligomer, a cyclic polyphenylsulfone oligomer, a cyclic polyetherimide oligomer, and co-oligomers thereof.

32. The method of claim 28, wherein the cyclic oligomer comprises a macrocyclic polyester oligomer.

33. The method of claim 28, wherein the linear polymer comprises at least one member selected from the group consisting of a polyester, a polyolefin, a polyformal, a polyphenylene oxide, a polyphenylene sulfide, a polyphenylsulfone, a polyetherimide, and co-polymers thereof.

34. A product produced by the process of claim 20.
